(19) United States
(12) Patent Application Publication
(10) Pub. No.: US 2026/0326387 A1
(43) Pub. Date: Oct. 22, 2026

(54) DESIGN AND FABRICATION OF HOLLOW OBJECTS USING PHOTOSENSITIVE RESIN

(71) Applicant: International Business Machines Corporation, Armonk, NY (US)

(72) Inventors: Martin G. KEEN, Cary, NC (US); Tushar AGRAWAL, West Fargo, ND (US); Carolina GARCIA DELGADO, Zapopan (MX); Sarbajit Kumar RAKSHIT, Kolkata (IN)

(21) Appl. No.: 19/186,049

(22) Filed: Apr. 22, 2025

(51) Int. Cl. B29C 64/393; B29C 64/124; B29L 22/00; B33Y 10/00; B33Y 50/02

(52) U.S. Cl. CPC B29C 64/393; B29C 64/124; B33Y 10/00; B33Y 50/02; B29L 2022/00

(57) ABSTRACT

In some implementations, a computer may generate a digital model of an object that is to be formed from a photosensitive resin, wherein the object is to have a hollow portion. The computer may use the digital model to determine a shape and dimensions of the hollow portion of the object. The computer may determine, based at least in part on the shape and the dimensions of the hollow portion, a shape and dimensions of an interior object that is to be used to form the hollow portion, wherein the interior object is to be immersed in the photosensitive resin, and wherein the object is to be formed around the interior object, resulting in the interior object being disposed in the hollow portion. The computer may execute a computer-generated simulation to determine whether the interior object can be removed from the hollow portion following formation of the object.

### BACKGROUND

This disclosure relates to computing systems, and more specifically, to design and fabrication of hollow objects using photosensitive resin.

### SUMMARY

Some aspects described herein relate to a method. The method may include generating a digital model of an object that is to be formed from a photosensitive resin, where the object is to have a hollow portion. The method may include using the digital model to determine a shape and dimensions of the hollow portion of the object. The method may include determining, based at least in part on the shape and the dimensions of the hollow portion, a shape and dimensions of an interior object that is to be used to form the hollow portion, where the interior object is to be immersed in the photosensitive resin, and where the object is to be formed around the interior object, resulting in the interior object being disposed in the hollow portion. The method may include executing a computer-generated simulation to determine whether the interior object can be removed from the hollow portion following formation of the object.

Some aspects described herein relate to a computer system. The computer system may include a processor set, one or more computer-readable storage media, and program instructions stored on the one or more computer-readable storage media to cause the processor set to perform operations. The operations may include determining a geometry of a hollow portion of a first object that is to be manufactured through an application of holographic ultraviolet (UV) light to photosensitive resin. The operations may include generating a digital model of the hollow portion. The operations may include executing a simulation with the digital model to determine a geometry of a second object that is to be used to form the hollow portion, where the second object is to be placed in the photosensitive resin, where the photosensitive resin is to be cured to form the first object around the second object, resulting in the second object being disposed in the hollow portion, and where the geometry of the second object is based at least in part on whether the second object can be removed from the hollow portion following formation of the first object.

Some aspects described herein relate to a computer program product. The computer program product may include one or more computer-readable storage media and program instructions stored on the one or more computer-readable storage media to perform operations. The operations may include generating a digital model of a hollow portion of a first object, where the first object is to be formed from a resin, and where the first object is to include a solid portion enclosing at least part of the hollow portion. The operations may include using the digital model in a plurality of computer-generated simulations to determine a shape and dimensions of a second object, where the shape and dimensions of the second object are to conform to a shape and dimensions of the hollow portion, where the second object is be submerged in the resin, where the first object is to be formed around the second object by curing the resin, resulting in the second object being disposed in the hollow portion, and where the shape and dimensions of the second object are controlled in the plurality of computer-generated simulations to produce a version of the second object that is predicted to be removable from the hollow portion without causing damage to the first object.

### BRIEF DESCRIPTION OF THE DRAWINGS

FIG. 1 is a diagram of an example computing environment for managing design and fabrication 3D objects described herein.

FIG. 2 is a block diagram of an example implementation associated with designing and fabricating a 3D object having a hollow portion.

FIG. 3A illustrates an example implementation of an object having a hollow portion.

FIG. 3B illustrates an example implementation of a shape and size of a hollow portion.

FIG. 3C illustrates an example implementation of an interior object around which an object is to be formed to create the hollow portion.

FIG. 4 illustrates an example implementation of part of an object generation system.

FIG. 5 is a flowchart of an example process associated with the design and fabrication of hollow objects using photosensitive resin.

FIG. 6 is a flowchart of an example process associated with design and fabrication of hollow objects using photosensitive resin.

FIG. 7 is a flowchart of an example process associated with design and fabrication of hollow objects using photosensitive resin.

FIG. 8 is a flowchart of an example process associated with design and fabrication of hollow objects using photosensitive resin.

### DETAILED DESCRIPTION

The following detailed description of example implementations refers to the accompanying drawings. The same reference numbers in different drawings may identify the same or similar elements.

Manufacturing hollow objects with photosensitive resin for mass production poses significant challenges. Current methods may fail to create hollow parts of an object, necessitating post-processing to achieve a desired hollow structure. This limitation results in increased production time and costs.

Current processes to create hollow objects when using photosensitive resin may involve post-processing operations to finish a product. Such post-processing may include, for example, utilizing additional photosensitive resin-based processes, performing layer-by-layer three-dimensional (3D) printing operations, machining, and/or other types of operations to create hollow cavities. This approach not only adds complexity to the manufacturing process but also limits the design flexibility and accuracy of the final product.

Furthermore, reliance on traditional machining techniques can be time-consuming and labor-intensive, leading to increased production costs and reduced efficiency. The lack of an efficient and effective method for creating 3D hollow objects with photosensitive resin hinders the widespread adoption of this technology in various industries, including aerospace, automotive, consumer products, and healthcare.

Some implementations described herein provide techniques to design and manage fabrication of hollow 3D objects formed from photosensitive resin. For example, a method may include generating a digital model of an object, determining the shape and dimensions of a hollow portion of the object, and determining the shape and dimensions of an interior object to be used to form the hollow portion. The interior object may be a solid object that conforms to the shape and dimensions of the hollow portion. In more detail, when manufacturing a hollow 3D object, the interior object may be immersed photosensitive resin, and holographic ultraviolet (UV) light may be projected around the interior object. The UV light solidifies (e.g., cures) the resin into the 3D object having the hollow portion, resulting in the 3D object being formed around the interior object, such that the interior object is in the hollow portion. The method may also include executing a computer-generated simulation to determine whether the interior object can be removed from the hollow portion following formation of the object.

In some aspects, the method may include computing the dimensions of a smallest bounding box enclosing the hollow portion, and/or electronically simulating immersion of the interior object in the photosensitive resin in alignment with a proposed location of the hollow portion. The method may also include computing a clearance between the interior object and a surrounding cured portion of the photosensitive resin to determine whether there is adequate space for the interior object to be removed from the hollow portion. Additionally, the method may include machine learning analysis to predict whether the interior object can be removed from the hollow portion.

In this way, the method reduces manufacturing process complexity and increases design flexibility and accuracy of a final product including a hollow portion. The method also minimizes the need for post-processing steps, which can reduce the object's production latency and conserve resources that would have otherwise been consumed by additional processing tasks. For example, the method reduces reliance on traditional machining techniques, which can be time-consuming and labor-intensive. The method permits the widespread adoption of using photosensitive resin to manufacture 3D hollow objects in various industries. Furthermore, the method enables precise control over the configuration of hollow portions of objects, allowing for the creation of complex hollow portions with improved accuracy and consistency.

Thus, the method may conserve processing resources, memory resources, and/or other resources that would have otherwise been consumed by manual post-processing, multiple fabrication iterations, and/or other issues. The method's efficiency and precision also enable it to be applied to a variety of technical domains, including manufacturing, aerospace, automotive, consumer products, and healthcare, where objects with complex and/or intricate hollow portions are often required.

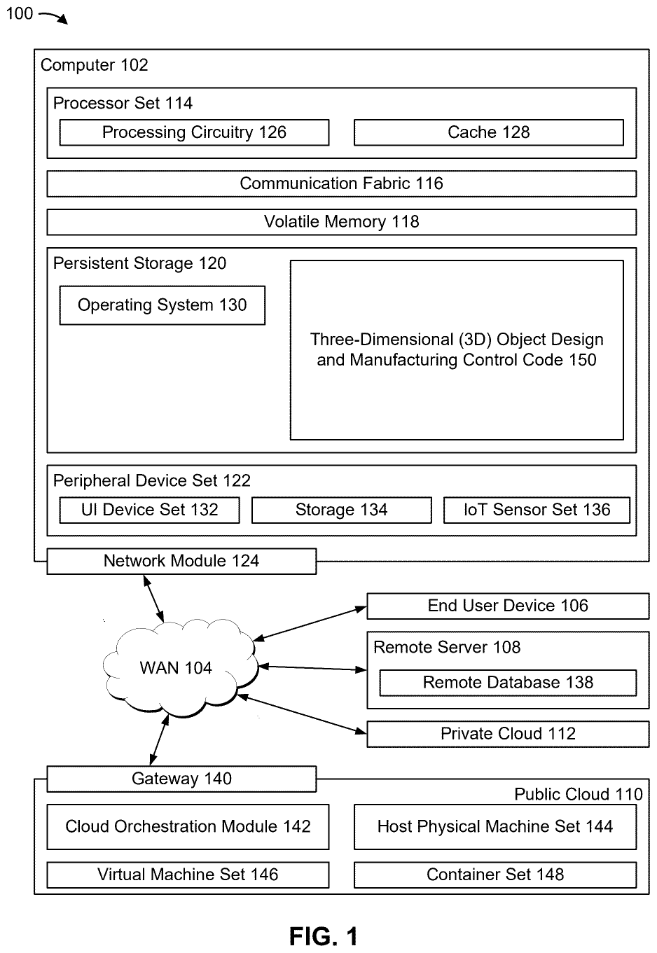

FIG. 1 is a diagram of an example computing environment 100 for managing design and fabrication 3D objects described herein.

The computing environment 100 contains an example of an environment for the execution of at least some of the computer code involved in performing the inventive methods, such as 3D object design and manufacturing control code 150. In addition to the 3D object design and manufacturing control code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the 3D object design and manufacturing control code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in 3D object design and manufacturing control code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input/output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the 3D object design and manufacturing control code 150 typically includes at least some of the computer code involved in performing one or more operations described herein. In some implementations, the operations may include generating a digital model of an object that is to be formed from a photosensitive resin, wherein the object is to have a hollow portion; using the digital model to determine a shape and dimensions of the hollow portion of the object; determining, based at least in part on the shape and the dimensions of the hollow portion, a shape and dimensions of an interior object that is to be used to form the hollow portion, wherein the interior object is to be immersed in the photosensitive resin, and wherein the object is to be formed around the interior object, resulting in the interior object being disposed in the hollow portion; and executing a computer-generated simulation to determine whether the interior object can be removed from the hollow portion following formation of the object.

In some implementations, the operations may include determining a geometry of a hollow portion of a first object that is to be manufactured through an application of holographic UV light to photosensitive resin; generating a digital model of the hollow portion; and executing a simulation with the digital model to determine a geometry of a second object that is to be used to form the hollow portion, wherein the second object is to be placed in the photosensitive resin, wherein the photosensitive resin is to be cured to form the first object around the second object, resulting in the second object being disposed in the hollow portion, and wherein the geometry of the second object is based at least in part on whether the second object can be removed from the hollow portion following formation of the first object.

In some implementations, the operations may include generating a digital model of a hollow portion of a first object, wherein the first object is to be formed from a resin, and wherein the first object is to include a solid portion enclosing at least part of the hollow portion; and using the digital model in a plurality of computer-generated simulations to determine a shape and dimensions of a second object, wherein the shape and dimensions of the second object are to conform to a shape and dimensions of the hollow portion, wherein the second object is be submerged in the resin, wherein the first object is to be formed around the second object by curing the resin, resulting in the second object being disposed in the hollow portion, and wherein the shape and dimensions of the second object are controlled in the plurality of computer-generated simulations to produce a version of the second object that is predicted to be removable from the hollow portion without causing damage to the first object.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

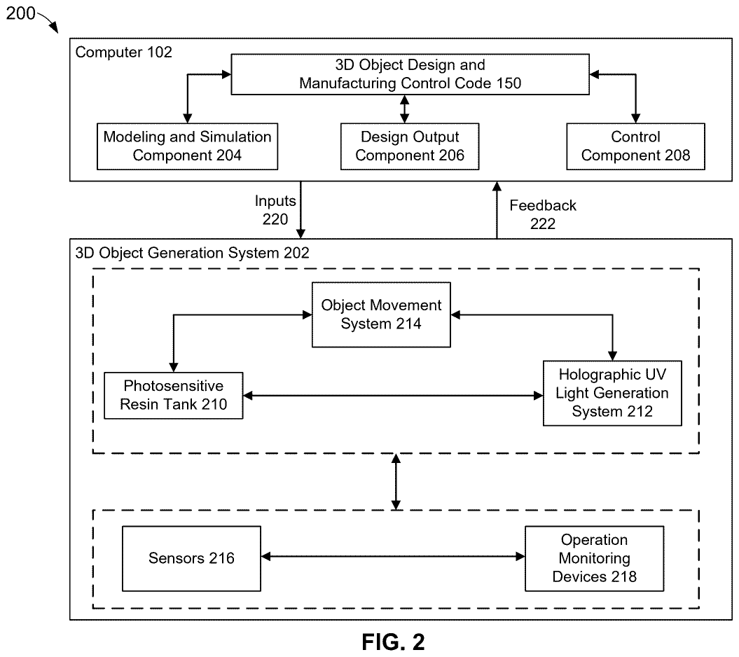

FIG. 2 is a block diagram of an example implementation 200 associated with designing and fabricating a 3D object having a hollow portion. As shown in FIG. 2, example implementation 200 includes a computer 102 that utilizes the 3D object design and manufacturing control code 150. The 3D object design and manufacturing control code 150 is used to design and manage fabrication of a 3D object having a hollow portion. Generation of the 3D object may be performed by the object generation system 202.

The 3D object design and manufacturing control code 150 includes a modeling and simulation component 204 that is used to generate digital models of the object having a hollow portion, of the hollow portion, and of an object representing the hollow portion that is to be used to form the hollow portion. The modeling and simulation component 204 uses computer-aided design techniques to design the object having a hollow portion, the hollow portion, and the object representing the hollow portion that is to be used to form the hollow portion. In some implementations, once the computer-aided designs are completed, the designs can be presented to designers, project managers, and other stakeholders to get feedback from, for example, the designers, project managers, and/or other stakeholders. The digital models can be modified based on the feedback.

In some implementations, the modeling and simulation component 204 may generate a digital model of an object with a hollow portion (also referred to herein as a “first object”) and determine the shape and dimensions of the hollow portion. The modeling and simulation component 204 may generate a mesh model to identify the hollow portion by identifying one or more regions of the object that lack material. The modeling and simulation component 204 may define a plurality of cross-sectional portions of the mesh model and compute the dimensions of the hollow portion within each cross-sectional portion. For example, the mesh model may be used to divide the hollow portion into smaller sections, and the dimensions of the hollow portion may be computed by totaling the computed dimensions of each section. In some implementations, the modeling and simulation component 204 may, based on the geometry (e.g., shape and dimensions) of the hollow portion, generate a digital model of the hollow portion. The digital model of the hollow portion may also be a mesh model.

Generating the mesh model may include breaking down the surfaces of the object including the hollow portion into a grid of interconnected vertices, edges, and faces (e.g., polygons). Once the mesh model is created, the modeling and simulation component 204 may analyze the mesh model to identify the hollow space. The computing techniques used for analyzing the model may examine the mesh model's surfaces and identify regions where there is no material, representing the hollow space. These areas may have fewer or no mesh faces.

The modeling and simulation component 204 may calculate the volume enclosed by the mesh model (e.g., the volume of the hollow portion) by subtracting the volume occupied by solid parts from the overall volume to determine the volume of the hollow portion. The modeling and simulation component 204 may use topological algorithms to identify cavities and voids within the mesh model, which can represent the hollow areas. For example, the modeling and simulation component 204 may use a flood fill algorithm to select a random point within an object and then “flood fill” the object until it reaches a boundary. If the fill operation encounters a closed boundary that does not connect to an outer boundary, it may indicate a hollow area. The modeling and simulation component 204 may use a boundary element method (BEM), which uses a mesh representation of the object to analyze the boundaries between elements to identify any closed loops that do not connect to an outer boundary, indicating hollow areas. The modeling and simulation component 204 may use a homotopy continuation algorithm, which uses a numerical method to track the topological features of an object, such as holes and voids, by continuously deforming a virtual object's shape and analyzing the resulting topology. The modeling and simulation component 204 may use a persistent homology algorithm, which uses algebraic topology to analyze the persistence of topological features, such as holes and voids, in an object at different scales. The modeling and simulation component 204 may use a voxel marching algorithm, which uses a 3D grid representation of an object and iteratively marches through the voxels, keeping track of the boundaries and identifying any closed loops that indicate hollow areas. The modeling and simulation component 204 may use a level set method algorithm, which uses a mathematical representation of an object's boundary as a level set of a function and then uses numerical methods to identify the topological features, including hollow areas. The modeling and simulation component 204 may use a clipping and capping algorithm, which uses clipping planes to remove parts of an object and capping algorithms to fill any resulting holes, thereby identifying hollow areas. The modeling and simulation component 204 may use a surface reconstruction algorithm, which uses point cloud or mesh data to reconstruct the surface of an object and identify any hollow areas. These topological algorithms can be used individually or in combination to identify hollow areas of an object, depending on the specific application and requirements.

The modeling and simulation component 204 may apply one or more computer vision and/or image analysis techniques to a mesh model to identify the shape and dimensions of the hollow portion. In some implementations, computer vision and image analysis techniques can be employed to analyze the shape and dimensions of the hollow portion by treating a 3D model as a 2D representation, such as a mesh or a point cloud, and then applying various algorithms to extract relevant features.

In a pre-processing step, the 3D model is converted into a suitable format, such as a mesh or a point cloud, to facilitate analysis. This may involve reducing the model's complexity, removing noise, and/or filling gaps in the data. Computer vision techniques, such as edge detection, corner detection, thresholding, region growing, image segmentation, 3D reconstruction, deep learning, and/or feature point extraction (e.g., a scale-invariant feature transform (SIFT) algorithm, or a speeded up robust features (SURF) algorithm), are applied to the 2D representation of the 3D model.

In more detail, edge detection algorithms, such as Canny edge detection and/or Sobel edge detection, can be used to identify the boundaries of an object and its hollow portions. Thresholding techniques, such as Otsu thresholding and/or binary thresholding, can be used to separate the object from its background and identify hollow portions. Region growing algorithms can be used to segment an image into regions of similar intensity or texture, helping to identify hollow portions. Feature point extraction algorithms, such as SIFT and/or SURF can be used to identify interest points in an image and determine the geometry of an object, including its hollow portions. Image segmentation algorithms, such as watershed segmentation and/or graph-based segmentation, can be used to separate an object into its constituent parts, including hollow portions. 3D reconstruction techniques, such as structure from motion (SfM) and/or multi-view stereo (MVS), can be used to create a 3D model of an object from multiple 2D images and determine its hollow portions.

In some implementations, deep learning algorithms, such as convolutional neural networks (CNNs) and/or recurrent neural networks (RNNs), can be trained on images of objects to learn patterns and features that indicate hollow portions. Point cloud processing may be used to analyze point clouds and/or extract features relevant to hollow portions.

In some implementations, the modeling and simulation component 204 may compute the dimensions of a smallest bounding box enclosing the hollow portion, where an axis of the bounding box is aligned with an axis of the hollow portion. For example, the bounding box may be used to determine the overall size and shape of the hollow portion.

Computing a smallest bounding box enclosing a hollow portion of an object can be achieved using various computer techniques. For example, the modeling and simulation component 204 may compute an oriented bounding box (OBB) using a principal component analysis (PCA) to perform a PCA of the hollow portion's vertices to determine its principal axes. The modeling and simulation component 204 may use a convex hull technique to compute the convex hull of the hollow portion's vertices to obtain a tight bounding volume, and/or K-discrete orientation polytope (K-DOP) algorithm to compute a compact bounding volume. The modeling and simulation component 204 may use a shrink wrapping technique to iteratively shrink the bounding box by moving its faces inward until they intersect with the hollow portion's boundaries and/or a box-mesh intersection technique to intersect the bounding box with the hollow portion's mesh to find the smallest enclosing box. Algorithms such as Gottschalk's algorithm to compute the OBB of a set of 3D points, Barequet's algorithm to compute the smallest enclosing box of a convex polyhedron, and/or O'Rourke's algorithm to determine the smallest enclosing box of a set of 3D points can further be used to compute a smallest bounding box that encloses the hollow portion of the object.

The modeling and simulation component 204 may determine, based at least in part on the shape and the dimensions of the hollow portion, a shape and dimensions of an interior object (also referred to herein as a “second object”) that is to be used to form the hollow portion. As explained in more detail herein, the interior object is to be immersed in a photosensitive resin, and the object having the hollow portion is to be formed around the interior object, resulting in the interior object being disposed in the hollow portion. The object having the hollow portion may be formed around the interior object by curing the photosensitive resin with holographic UV light. As explained in more detail herein, the shape and dimensions of the interior object are to conform to a shape and dimensions of the hollow portion.

The modeling and simulation component 204 may perform one or more computer-generated simulations using the digital model of the object having the hollow portion and/or the digital model of the hollow portion to determine a geometry (e.g., shape and dimensions) of the interior object that is to be used to form the hollow portion. The geometry of the interior object is based at least in part on whether the interior object can be removed from the hollow portion following formation of the object having the hollow portion around the interior object.

For example, the modeling and simulation component 204 may execute one or more computer-generated simulations to determine whether the interior object can be removed from the hollow portion following formation of the object. The simulation(s) may be used to model the removal process and determine whether the interior object can be removed without damaging the object. In more detail, the modeling and simulation component 204 may electronically simulate immersion of the interior object in the photosensitive resin in alignment with a proposed location of the hollow portion, and compute, based at least in part on the shape and the dimensions of the hollow portion, and the shape and the dimensions of the interior object, a clearance between the interior object and a surrounding cured portion of the photosensitive resin to determine whether there is adequate space for the interior object to be removed from the hollow portion. As used herein, “adequate space” may refer to a sufficient spacing between an outer surface of the interior object and a surrounding surface of a cured (e.g., solid) portion of the photosensitive resin to permit the interior object to be removed from the hollow portion without causing damage to or breakage of any portion of the object having the hollow portion. In other words, the modeling and simulation component 204 may compute a minimum spacing between the interior object and a portion of the photosensitive resin to permit removal of the interior object. For example, the minimum spacing may be used to determine the optimal distance between the interior object and the cured resin. In some implementations, the simulations may include simulating the use of a robotic system to insert and immerse (e.g., submerge) the interior object in a tank filled with photosensitive resin, and/or simulating the use of a robotic system to remove the interior object from the hollow portion.

The modeling and simulation component 204 may use one or more machine learning algorithms to perform machine learning analysis to determine whether the interior object can be removed from the hollow portion. The machine learning algorithm may be trained with a dataset comprising data indicating successful removals of a plurality of interior objects from a plurality of hollow portions, unsuccessful attempts to remove the plurality of interior objects from the plurality of hollow portions, shapes and dimensions of the plurality of hollow portions associated with the successful removals and/or the unsuccessful attempts to remove, and/or shapes and dimensions of the plurality of interior objects associated with the successful removals and/or the unsuccessful attempts to remove.

In some implementations, in response to determining that the interior object cannot be removed from the hollow portion following formation of the object, the modeling and simulation component 204 may generate designs where the interior object is divided into two or more portions and execute additional computer-generated simulations to determine whether the interior object that has been divided into the two or more portions can be removed from the hollow portion following formation of the object. The division of the interior object may be performed along one or more axes (e.g., vertical, horizontal, and/or other axes at different angles) of the interior object so that divided portions of the interior object can be removed from the hollow portion in different steps from each other. The modeling and simulation component 204 may validate whether one or more robotic arms can place the divided portions into the photosensitive resin and/or remove the divided portions from the hollow portion following curing of the photosensitive resin. In some implementations, the simulations may identify an approximate hollow shape that may be formed when using a combination of multiple segmented interior objects immersed in a photosensitive resin.

If after performing multiple simulations, the modeling and simulation component 204 is not able to develop a design of the interior object that can be successfully removed from the hollow portion, the modeling and simulation component 204 may evaluate design modifications to the object and/or post-processing techniques to generate an object having a designated hollow portion configuration.

In some implementations, the design output component 206 of the 3D object design and manufacturing control code 150 may generate design data for the object, the hollow portion, and/or the interior object that is transmitted to the object generation system 202 in the form of inputs 220. The control component 208 of the 3D object design and manufacturing control code 150 may generate operation control data that is transmitted to the object generation system 202 in the form of inputs 220. For example, the inputs 220 from the design output component 206 and/or the control component 208 may include data specifying the shape and dimensions of the hollow portion of the object, the shape and dimensions of the interior object, the minimum spacing (e.g., clearance) between the interior object and a portion of the photosensitive resin to be cured around the interior object to permit the interior object to be removed from the hollow portion following formation of the object, a location for immersion of the interior object in a photosensitive resin tank 210, and/or data specifying whether the interior object is to be divided. The inputs 220 from the design output component 206 may further include direction and/or orientation data for holographic UV light sources of a holographic UV light generation system 212.

For example, based on inputs 220 specifying an alignment of the interior object in the photosensitive resin, an object movement system 214, which may include one or more robotic systems including one or more robotic arms, may immerse an interior object at a specific location within a photosensitive resin tank 210. In addition, based on the specified alignment of the interior object in the photosensitive resin, the data specifying the shape and dimensions of the hollow portion of the object, the minimum spacing (e.g., clearance) between the interior object and the cured photosensitive resin, and/or the holographic UV light source direction and/or orientation data, the holographic UV light generation system 212 may orient and/or move holographic UV light sources to control the direction of the holographic UV light to achieve a desired geometry of the object and hollow portion being formed from the cured photosensitive resin.

Outputs from the control component 208, which may be provided as inputs 220 to the 3D object generation system 202 may include, for example, an output, based at least in part on the simulation(s), including alignment and/or position data to control an object movement system 214 to place the interior object in the photosensitive resin, and an output, based at least in part on the simulation(s), to control the object movement system 214 to remove the interior object from the hollow portion following formation of the object. Additionally, or alternatively, the control component 208 may be provide inputs 220 to the 3D object generation system 202 including control data to align an array of holographic UV projectors of the holographic UV light generation system 212 around the interior object to ensure synchronized projection of holographic UV light onto the photosensitive resin in the photosensitive resin tank 210.

The object generation system 202 includes one or more sensors 216 and one or more operation monitoring devices 218, which may be used to monitor 3D object generation operations. For example, the sensors 216 may include motion sensors and the operation monitoring devices 218 may include digital image sources (e.g., still and/or video image cameras) indicating whether movement of the photosensitive resin is occurring due to placement of the interior object in the photosensitive resin. Feedback 222 including the motion sensor data and/or timestamped still and/or video image data may be sent to the control component 208 from the 3D object generation system 202, and used by the control component 208 to control when to start projection of the holographic UV light by the holographic UV light generation system 212. For example, the holographic UV light projection may be delayed until there is no movement of the photosensitive resin. The sensors 216 and operation monitoring devices 218 can be used to monitor the resin and detect any turbulence or disturbances caused by the immersion of the interior object. Once the control component 208 receives feedback 222 indicating that the turbulence has subsided, the control component 208 can send inputs 220 to the holographic UV light generation system 212 commanding the holographic UV light generation system 212 to proceed with the holographic UV light projection to manufacture the hollow 3D object.

The operation monitoring devices 218 may be used to capture images and/or video of the resulting object with the hollow portion to determine whether the object is intact (e.g., was not damaged or broken following removal of the interior object), whether the shape and dimensions of the object and hollow portions are within acceptable limits and/or conform to designated specifications, and/or whether the object has an acceptable quality. The digital image and/or video representations captured by the one or more operation monitoring devices 218 may be transmitted to the control component 208 as feedback 222. The control component 208 may use the feedback to control the object movement system 214 and/or the holographic UV light generation system 212 to adjust parameters such as the alignment of the interior object and/or the alignment of the holographic UV light sources. For example, an alignment process of an array of holographic UV projectors of the holographic UV light generation system 212 around the interior object immersed in photosensitive resin may involve adjusting the position and orientation of the projectors based on feedback from sensors 216 and/or operation monitoring device 218 to achieve optimal coverage and minimize any gaps or overlaps. The aligned projectors can then be used to project the holographic UV light and manufacture the hollow 3D object.

In some implementations, the feedback 222 is used by the modeling and simulation component 204 and/or the 3D object design and manufacturing control code 150 to modify the digital models and/or retrain machine learning algorithms used in connection with identifying the shapes and dimensions of the object having the hollow portion, the shapes and dimensions of the hollow portion, the shapes and dimensions of the interior object, the clearance between the interior object and the cured resin, the alignment of the interior object and/or the alignment of the holographic UV light sources. For example, the feedback 222 may be used to retrain the machine learning algorithm(s) based on whether the interior object was able to be removed from the hollow portion following formation of the object. Such iterative retraining of the machine learning algorithm(s) may improve its accuracy.

In some implementations, based on the results of the simulations from the modeling and simulation component 204, the designs from the design output component 206, and/or the feedback 222, the control component 208 may dynamically create a production line to generate the object having the hollow portion. The production line may include coordinating the photosensitive resin tank 210, the holographic UV light generation system 212, the object movement system 214, and/or other components to control photosensitive resin-based manufacturing, and/or other processing or post-processing equipment that may be required. The production line can be optimized to ensure efficient and cost-effective production of the hollow 3D object.

FIG. 2 is provided as an example. Other examples may differ from what is described with regard to FIG. 2.

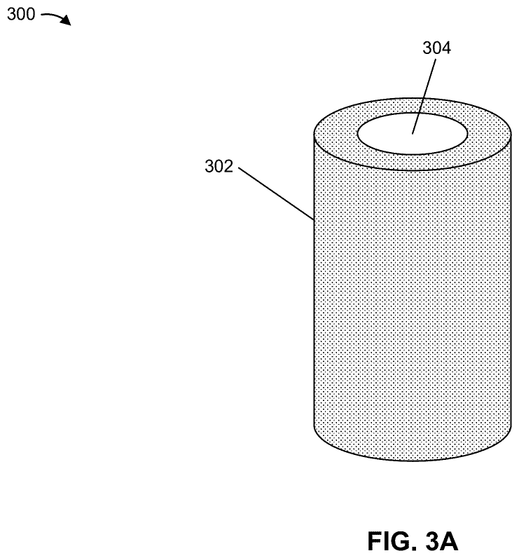

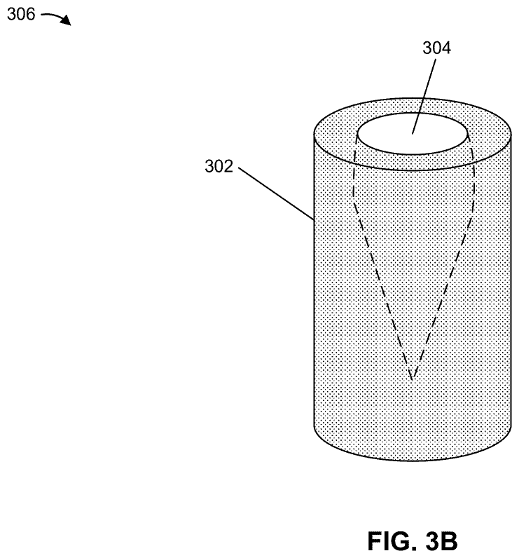

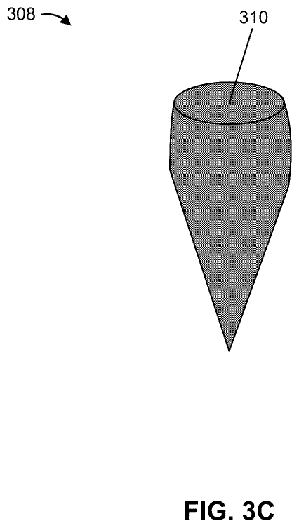

FIG. 3A illustrates an example implementation 300 of an object 302 having a hollow portion 304. As used herein, “hollow portion” may refer to a region or cavity within an object that is not filled with material, resulting in an empty or void space. In other words, it is a part of the object that is not solid, but rather an enclosed or partially enclosed space that is not occupied by the object's material. The hollow portion may be surrounded by the object's material, either completely or partially, creating a distinct boundary between the hollow space and the surrounding solid material. As described in more detail in connection with FIG. 3B, hollow portions can be three-dimensional, with a distinct volume, shape, and size. Hollow portions can be found in a wide range of objects, including, for example, mechanical components, such as engine blocks or pumps, hollow tubes or pipes, prosthetics or other medical devices and/or implants, aerospace and/or aircraft components, and/or consumer products such as toys.

FIG. 3B illustrates an example implementation 306 of a shape and size of hollow portion 304. As shown by the dotted lines in FIG. 3B, the hollow portion 304 has a designated volume, shape, and size within an interior portion of the object 302. For example, the hollow portion 304 has a partial cylindrical/cone-shape.

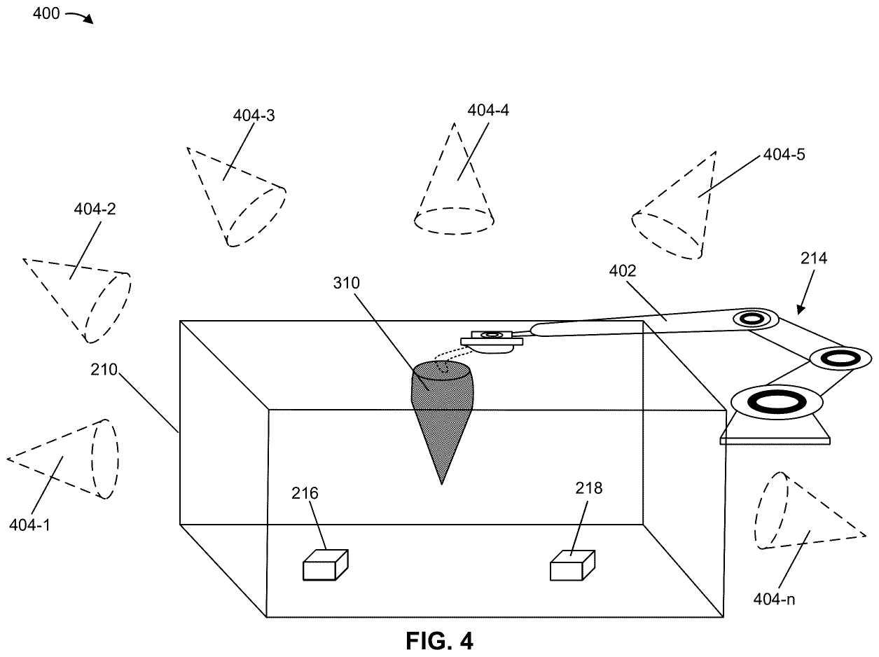

FIG. 3C illustrates an example implementation 308 of an interior object 310 around which the object 302 is to be formed to create the hollow portion 304. As shown in the example implementation 308, the interior object 310 is a solid object having the same or substantially the same shape and dimensions as the hollow portion 304. In this way, as described in more detail in connection with FIG. 4, the interior object 310 may act as a placeholder/mold for the hollow portion 304. In more detail, when the interior object 310 is immersed in photosensitive resin in, for example, a photosensitive resin tank 210, photosensitive resin is cured around the interior object 310 by the application of holographic UV light from a plurality of holographic UV light sources. As a result, the object 302 is formed around the interior object 310, resulting in the interior object 310 being disposed in the hollow portion 304. Following the curing process, the interior object 310 is removed from the hollow portion 304.

As noted herein, the alignment and immersion of the interior object 310 in the photosensitive resin, and the removal of the interior object 310 from the hollow portion 304 may be performed by a robotic arm of an object movement system 214 controlled by the control component 208. In addition, the alignment of the plurality of holographic UV light sources, and the application of the holographic UV light from the plurality of holographic UV light sources of the holographic UV light generation system 212 may be controlled by the control component 208.

As noted herein, in some implementations, depending on whether an interior object can be removed from a hollow portion of an object without damaging the object, the interior object may be divided into two or more portions along one or more axes of the interior object so that the portions of the interior object can be respectively removed without damaging the object.

FIGS. 3A-3C are provided as examples. Other examples may differ from what is described with regard to FIGS. 3A-3C.

FIG. 4 illustrates an example implementation 400 of part of the object generation system 202. As shown in FIG. 4, a robotic arm 402 of an object movement system 214 is configured to place (e.g., immerse) the interior object 310 in photosensitive resin that is accommodated in a photosensitive resin tank 210. Based on inputs 220 specifying an alignment of the interior object 310 in the photosensitive resin, the object movement system 214 including the robotic arm 402, may immerse the interior object 310 at a specific location within the photosensitive resin tank 210. In addition, based on the specified alignment of the interior object in the photosensitive resin, the data specifying the shape and dimensions of the hollow portion of the object, the minimum spacing (e.g., clearance) between the interior object and the cured photosensitive resin, and/or the holographic UV light source direction and/or orientation data, the holographic UV light generation system 212 may orient a plurality (e.g., array) of holographic UV light projection devices 404-1, 404-2, 404-3, 404-4, 404-5, . . . , 404-n (collectively “UV light projection devices 404”, where n is an integer greater than 1) to control the direction of the holographic UV light to achieve a desired geometry of the object 302 and hollow portion 304 being formed from the cured photosensitive resin.

Outputs from the control component 208, which may be provided as inputs 220 to the 3D object generation system 202 may include, for example, an output, based at least in part on the simulation(s), including alignment and/or position data to control an object movement system 214 to place the interior object 310 in the photosensitive resin, and an output, based at least in part on the simulation(s), to control the object movement system 214 to remove the interior object 310 from the hollow portion 304 following formation of the object 302. Additionally, or alternatively, the control component 208 may be provide inputs 220 to the 3D object generation system 202 including control data to align an array of holographic UV light projection devices 404 of the holographic UV light generation system 212 around the interior object 310 to ensure synchronized projection of holographic UV light onto the photosensitive resin in the photosensitive resin tank 210. In some implementations, inputs 220 from the control component 208 may include data regarding movement of one or more of the holographic UV light projection devices 404 during the projection/curing process in order to a achieve a desired shape and/or configuration of the object 302.

One or more sensors 216 (e.g., motion sensors) and one or more operation monitoring devices 218 (e.g., digital image sources) may be included in the photosensitive resin tank 210 to indicate whether movement of the photosensitive resin is occurring due to placement of the interior object 310 in the photosensitive resin. As noted herein, feedback 222 including the motion sensor data and/or timestamped still and/or video image data may be sent to the control component 208 from the 3D object generation system 202, and used by the control component 208 to control when to start projection of the holographic UV light by the holographic UV light projection devices 404. For example, the holographic UV light projection may be delayed until there is no movement of the photosensitive resin. After the curing process and formation of the object 302, the robotic arm 402 may be controlled by the control component 208 to remove the interior object 310 from the hollow portion 304.

FIG. 4 is provided as an example. Other examples may differ from what is described with regard to FIG. 4.

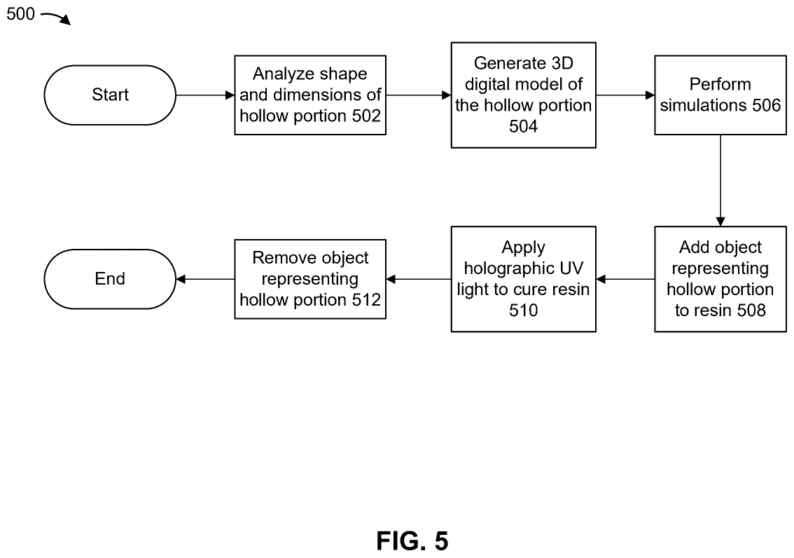

FIG. 5 is a flowchart of an example process 500 associated with the design and fabrication of hollow objects using photosensitive resin. In the example process 500, the 3D object design and manufacturing control code 150 (e.g., the modeling and simulation component 204) analyzes the shape and dimensions of a hollow portion of a 3D object (block 502). As described herein, the analysis of the shape and dimensions of a hollow portion of a 3D object may be performed using various techniques such as mesh modeling, BEMs, flood fill algorithms, topological algorithms, computer vision techniques, and/or image segmentation.

In the example process 500, based on the shape and dimensions of the hollow portion, the 3D object design and manufacturing control code 150 (e.g., the modeling and simulation component 204) generates a 3D digital model of the hollow portion (block 504). In some implementations, the digital model of the hollow portion may be a mesh model. Generating a mesh model of the hollow portion may include simulating a shape and surfaces of the hollow portion, and breaking down the surfaces into a grid of interconnected vertices, edges, and faces (e.g., polygons).

Using the 3D digital model of the hollow portion and/or a 3D model of the object having the hollow portions, the 3D object design and manufacturing control code 150 (e.g., the modeling and simulation component 204) performs a plurality of simulations (block 506). For example, the modeling and simulation component 204 may execute one or more computer-generated simulations to determine whether a solid object (e.g., interior object) used as a placeholder/mold to form the hollow portion can be removed from the hollow portion following formation of the object from cured photosensitive resin. The simulation(s) may model immersion of the solid object in uncured photosensitive resin and/or removal of the solid object from a hollow portion after curing of the photosensitive resin to determine whether the solid object can be removed without damaging the object. As a result of the simulations, the modeling and simulation component 204 may determine the shape and dimensions of a version of the solid object that is predicted to be removable from the hollow portion without causing damage to the object having the hollow portion. As a result of the simulations, the modeling and simulation component 204 may determine a clearance between a portion of the object having the hollow portion and an outer surface of the solid object that will permit removal of the solid object from the hollow portion without causing damage to the object having the hollow portion.

Based on the results of the simulations, and resulting geometries of a design of the solid object and the object having the hollow portion, which may be output from the design output component 206, the control component 208 provides inputs 220 to the object generation system 202 so that the object movement system 214 (e.g., robotic arm 402) may add the object representing the hollow portion (e.g., solid/interior object) to the photosensitive resin (block 508). As noted herein, the inputs 220 may include alignment data for pinpointing a location of the object representing the hollow portion in the photosensitive resin. Following the addition of the object representing the hollow portion to the photosensitive resin, the control component 208 may control the application of holographic UV light to the photosensitive resin to cure the photosensitive resin (block 510). In connection with applying holographic UV light to the photosensitive resin, the control component 208 may provide inputs 220 to the object generation system 202 (e.g., holographic UV light generation system 212) that specify, for example, when to start the light projection process (e.g., based on movement of the photosensitive resin subsiding after insertion of the object representing the hollow portion into the photosensitive resin), and/or positioning and/or movement of the light sources (e.g., holographic UV light projection devices 404) before and/or during the light projection process.

After the photosensitive resin is cured to form the object having the hollow portion, the control component 208 provides inputs 220 to the object generation system 202 so that the object movement system 214 (e.g., robotic arm 402) may remove the object representing the hollow portion (e.g., solid/interior object) from the hollow portion (block 512). The inputs 220 may include data specifying the location of the object representing the hollow portion in the hollow portion, data specifying the clearance between the object representing the hollow portion and a surrounding cured portion of the photosensitive resin, and/or data specifying a shape and dimensions of the object having the hollow portion, of the hollow portion, and/or of the object representing the hollow portion.

FIG. 5 is provided as an example. Other examples may differ from what is described with regard to FIG. 5.

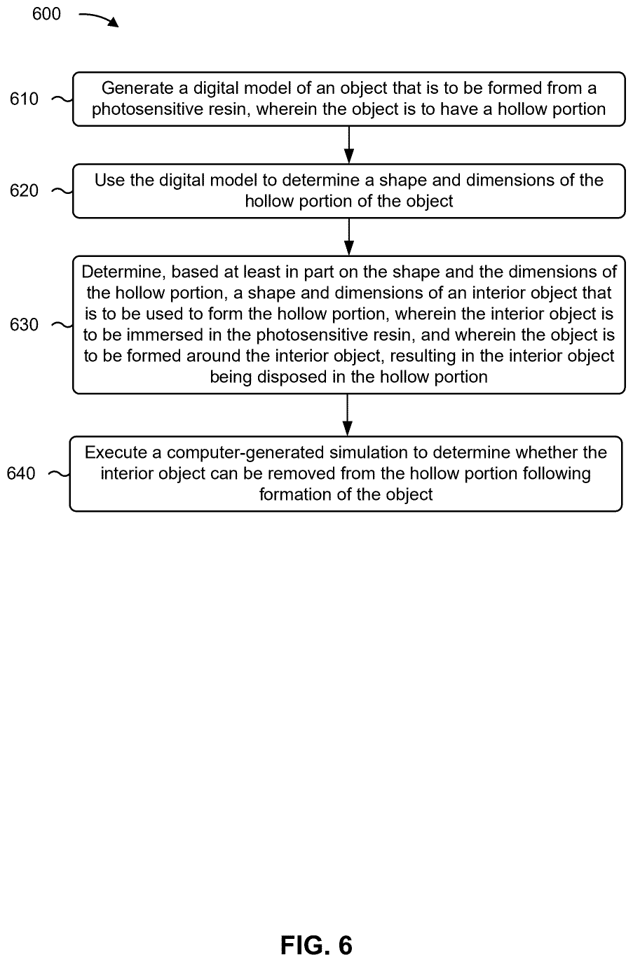

FIG. 6 is a flowchart of an example process 600 associated with design and fabrication of hollow objects using photosensitive resin. One or more process blocks of FIG. 6 are performed by a computer (e.g., computer 102 including 3D object design and manufacturing control code 150) and/or by another device or a group of devices separate from or including the computer, such as a holographic UV light generation system (e.g., holographic UV light generation system 212), an object movement system (e.g., object movement system 214), sensors (e.g., sensors 216), and/or operation monitoring devices (e.g., operation monitoring devices 218). Additionally, or alternatively, one or more process blocks of FIG. 6 may be performed by one or more components of the computer 102, such as the processor set 114, communication fabric 116, volatile memory 118, persistent storage 120, operating system 130, peripheral device set 122, and/or network module 124.

As shown in FIG. 6, process 600 includes generating a digital model of an object that is to be formed from a photosensitive resin, wherein the object is to have a hollow portion (block 610). For example, the computer may generate a digital model of an object that is to be formed from a photosensitive resin, wherein the object is to have a hollow portion, as described above.

As further shown in FIG. 6, process 600 includes using the digital model to determine a shape and dimensions of the hollow portion of the object (block 620). For example, the computer may use the digital model to determine a shape and dimensions of the hollow portion of the object, as described above.

As further shown in FIG. 6, process 600 includes determining, based at least in part on the shape and the dimensions of the hollow portion, a shape and dimensions of an interior object that is to be used to form the hollow portion, wherein the interior object is to be immersed in the photosensitive resin, and wherein the object is to be formed around the interior object, resulting in the interior object being disposed in the hollow portion (block 630). For example, the computer may determine, based at least in part on the shape and the dimensions of the hollow portion, a shape and dimensions of an interior object that is to be used to form the hollow portion, wherein the interior object is to be immersed in the photosensitive resin, and wherein the object is to be formed around the interior object, resulting in the interior object being disposed in the hollow portion, as described above.

As further shown in FIG. 6, process 600 includes executing a computer-generated simulation to determine whether the interior object can be removed from the hollow portion following formation of the object (block 640). For example, the computer may execute a computer-generated simulation to determine whether the interior object can be removed from the hollow portion following formation of the object, as described above.

Process 600 may include additional aspects, such as any single aspect or any combination of aspects described below and/or in connection with one or more other processes described elsewhere herein.

In a first aspect, generating the digital model comprises generating a mesh model of the object, wherein the mesh model is used to identify the hollow portion by identifying one or more regions of the object that lack material.

In a second aspect, alone or in combination with the first aspect, process 600 includes defining a plurality of cross-sectional portions of the mesh model, and computing the dimensions of the hollow portion within each cross-sectional portion of the plurality of cross-sectional portions.

In a third aspect, alone or in combination with one or more of the first and second aspects, process 600 includes computing, based at least in part on the shape and the dimensions of the hollow portion, dimensions of a smallest bounding box enclosing the hollow portion, wherein an axis of the bounding box is aligned with an axis of the hollow portion.

In a fourth aspect, alone or in combination with one or more of the first through third aspects, executing the computer-generated simulation comprises electronically simulating immersion of the interior object in the photosensitive resin in alignment with a proposed location of the hollow portion.

In a fifth aspect, alone or in combination with one or more of the first through fourth aspects, executing the computer-generated simulation comprises computing, based at least in part on the shape and the dimensions of the hollow portion, and the shape and the dimensions of the interior object, a clearance between the interior object and a surrounding cured portion of the photosensitive resin to determine whether there is adequate space for the interior object to be removed from the hollow portion.

In a sixth aspect, alone or in combination with one or more of the first through fifth aspects, determining whether the interior object can be removed from the hollow portion is based at least in part on a machine learning analysis by a machine learning algorithm, wherein the machine learning algorithm is trained with a dataset comprising data indicating at least one of successful removals of a plurality of interior objects from a plurality of hollow portions, unsuccessful attempts to remove the plurality of interior objects from the plurality of hollow portions, shapes and dimensions of the plurality of hollow portions associated with at least one of the successful removals or the unsuccessful attempts to remove, or shapes and dimensions of the plurality of interior objects associated with at least one of the successful removals or the unsuccessful attempts to remove.

In a seventh aspect, alone or in combination with one or more of the first through sixth aspects, process 600 includes providing feedback to the machine learning algorithm to retrain the machine learning algorithm based on whether the interior object was able to be removed from the hollow portion following formation of the object.

In an eighth aspect, alone or in combination with one or more of the first through seventh aspects, process 600 includes generating, in response to determining that the interior object cannot be removed from the hollow portion following formation of the object, one or more designs where the interior object is divided into two or more portions, and executing one or more additional computer-generated simulations to determine whether the interior object divided into the two or more portions can be removed from the hollow portion following formation of the object.

In a ninth aspect, alone or in combination with one or more of the first through eighth aspects, process 600 includes identifying, based at least in part on the computer-generated simulation, an alignment of the interior object in the photosensitive resin, wherein the alignment corresponds to a designated location of the hollow portion, and controlling, based at least in part on the alignment, an object movement system to immerse the interior object in the photosensitive resin.

In an tenth aspect, alone or in combination with one or more of the first through ninth aspects, process 600 includes controlling, based at least in part on the alignment, a direction of holographic UV light projected onto the photosensitive resin.

In an eleventh aspect, alone or in combination with one or more of the first through tenth aspects the controlling of the object movement system and the controlling of the direction of the holographic UV light is based at least in part on feedback data including at least one of sensor data or image data associated with the interior object in the photosensitive resin.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

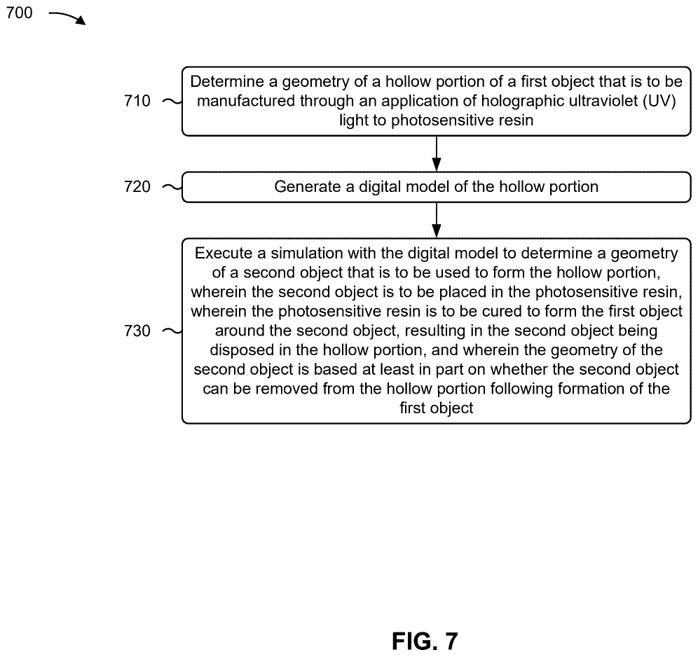

FIG. 7 is a flowchart of an example process 700 associated with design and fabrication of hollow objects using photosensitive resin. One or more process blocks of FIG. 7 are performed by a computer system (e.g., computer 102 including 3D object design and manufacturing control code 150) and/or by another device or a group of devices separate from or including the computer system, such as a holographic UV light generation system (e.g., holographic UV light generation system 212), an object movement system (e.g., object movement system 214), sensors (e.g., sensors 216), and/or operation monitoring devices (e.g., operation monitoring devices 218). Additionally, or alternatively, one or more process blocks of FIG. 7 may be performed by one or more components of the computer 102, such as the processor set 114, communication fabric 116, volatile memory 118, persistent storage 120, operating system 130, peripheral device set 122, and/or network module 124.

As shown in FIG. 7, process 700 includes determining a geometry of a hollow portion of a first object that is to be manufactured through an application of holographic UV light to photosensitive resin (block 710). For example, the computer system may determine a geometry of a hollow portion of a first object that is to be manufactured through an application of holographic UV light to photosensitive resin, as described above.

As further shown in FIG. 7, process 700 includes generating a digital model of the hollow portion (block 720). For example, the computer system may generate a digital model of the hollow portion, as described above.

As further shown in FIG. 7, process 700 includes executing a simulation with the digital model to determine a geometry of a second object that is to be used to form the hollow portion, wherein the second object is to be placed in the photosensitive resin, wherein the photosensitive resin is to be cured to form the first object around the second object, resulting in the second object being disposed in the hollow portion, and wherein the geometry of the second object is based at least in part on whether the second object can be removed from the hollow portion following formation of the first object (block 730). For example, the computer system may execute a simulation with the digital model to determine a geometry of a second object that is to be used to form the hollow portion, wherein the second object is to be placed in the photosensitive resin, wherein the photosensitive resin is to be cured to form the first object around the second object, resulting in the second object being disposed in the hollow portion, and wherein the geometry of the second object is based at least in part on whether the second object can be removed from the hollow portion following formation of the first object, as described above.

Process 700 may include additional aspects, such as any single aspect or any combination of aspects described below and/or in connection with one or more other processes described elsewhere herein.

In a first aspect, process 700 includes computing, based at least in part on the simulation, a minimum spacing between the second object and a portion of the photosensitive resin to be cured around the second object to permit the second object to be removed from the hollow portion following formation of the first object.

In a second aspect, alone or in combination with the first aspect, process 700 includes generating a first output based at least in part on the simulation to control a robotic system to place the second object in the photosensitive resin, and generating a second output based at least in part on the simulation to control the robotic system to remove the second object from the hollow portion following formation of the first object.

In a third aspect, alone or in combination with one or more of the first and second aspects, process 700 includes receiving feedback from at least one of a sensor or a digital image source indicating whether movement of the photosensitive resin is occurring due to placement of the second object in the photosensitive resin, and generating an output based at least in part on the feedback to control timing of the application of the holographic UV light to the photosensitive resin.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

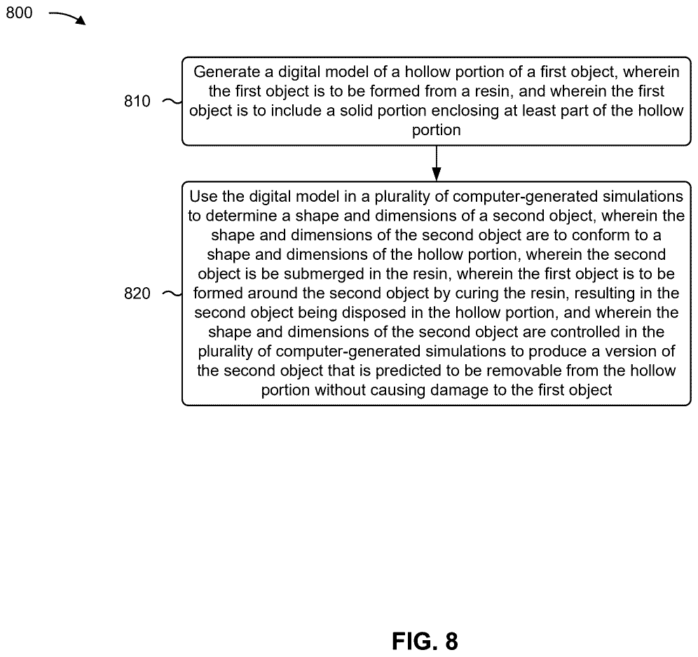

FIG. 8 is a flowchart of an example process 800 associated with design and fabrication of hollow objects using photosensitive resin. One or more process blocks of FIG. 8 are performed by a computer product (e.g., computer 102 including 3D object design and manufacturing control code 150) and/or by another device or a group of devices separate from or including the computer product, such as a holographic UV light generation system (e.g., holographic UV light generation system 212), an object movement system (e.g., object movement system 214), sensors (e.g., sensors 216), and/or operation monitoring devices (e.g., operation monitoring devices 218). Additionally, or alternatively, one or more process blocks of FIG. 8 may be performed by one or more components of the computer 102, such as the processor set 114, communication fabric 116, volatile memory 118, persistent storage 120, operating system 130, peripheral device set 122, and/or network module 124.

As shown in FIG. 8, process 800 includes generating a digital model of a hollow portion of a first object, wherein the first object is to be formed from a resin, and wherein the first object is to include a solid portion enclosing at least part of the hollow portion (block 810). For example, the computer product may generate a digital model of a hollow portion of a first object, wherein the first object is to be formed from a resin, and wherein the first object is to include a solid portion enclosing at least part of the hollow portion, as described above.

As further shown in FIG. 8, process 800 includes using the digital model in a plurality of computer-generated simulations to determine a shape and dimensions of a second object, wherein the shape and dimensions of the second object are to conform to a shape and dimensions of the hollow portion, wherein the second object is be submerged in the resin, wherein the first object is to be formed around the second object by curing the resin, resulting in the second object being disposed in the hollow portion, and wherein the shape and dimensions of the second object are controlled in the plurality of computer-generated simulations to produce a version of the second object that is predicted to be removable from the hollow portion without causing damage to the first object (block 820). For example, the computer product may use the digital model in a plurality of computer-generated simulations to determine a shape and dimensions of a second object, wherein the shape and dimensions of the second object are to conform to a shape and dimensions of the hollow portion, wherein the second object is be submerged in the resin, wherein the first object is to be formed around the second object by curing the resin, resulting in the second object being disposed in the hollow portion, and wherein the shape and dimensions of the second object are controlled in the plurality of computer-generated simulations to produce a version of the second object that is predicted to be removable from the hollow portion without causing damage to the first object, as described above.

Process 800 may include additional aspects, such as any single aspect or any combination of aspects described below and/or in connection with one or more other processes described elsewhere herein.

In a first aspect, process 800 includes computing, based at least in part on a computer-generated simulation of the plurality of computer-generated simulations simulating formation of the first object around the second object, a clearance between the solid portion of the first object and an outer surface of the second object.

In a second aspect, alone or in combination with the first aspect, process 800 includes determining, based at least in part on an additional computer-generated simulation of the plurality of computer-generated simulations simulating removal of the second object from the hollow portion, whether the clearance will permit removal of the second object from the hollow portion without causing damage to the first object.

In a third aspect, alone or in combination with one or more of the first and second aspects, process 800 includes determining, based at least in part on the plurality of computer-generated simulations, that the version of the second object is to be divided along at least one axis to permit removal of the second object from the hollow portion without causing damage to the first object.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
generating a digital model of an object that is to be formed from a photosensitive resin,
wherein the object is to have a hollow portion;
using the digital model to determine a shape and dimensions of the hollow portion of the object;
determining, based at least in part on the shape and the dimensions of the hollow portion, a shape and dimensions of an interior object that is to be used to form the hollow portion,
wherein the interior object is to be immersed in the photosensitive resin, and
wherein the object is to be formed around the interior object, resulting in the interior object being disposed in the hollow portion; and
executing a computer-generated simulation to determine whether the interior object can be removed from the hollow portion following formation of the object.

2. The method of claim 1 wherein generating the digital model comprises generating a mesh model of the object, and
wherein the mesh model is used to identify the hollow portion by identifying one or more regions of the object that lack material.

3. The method of claim 2 further comprising:
defining a plurality of cross-sectional portions of the mesh model; and
computing the dimensions of the hollow portion within each cross-sectional portion of the plurality of cross-sectional portions.

4. The method of claim 1 further comprising computing, based at least in part on the shape and the dimensions of the hollow portion, dimensions of a smallest bounding box enclosing the hollow portion,
wherein an axis of the bounding box is aligned with an axis of the hollow portion.

5. The method of claim 1 wherein executing the computer-generated simulation comprises electronically simulating immersion of the interior object in the photosensitive resin in alignment with a proposed location of the hollow portion.

6. The method of claim 1 wherein executing the computer-generated simulation comprises computing, based at least in part on the shape and the dimensions of the hollow portion, and the shape and the dimensions of the interior object, a clearance between the interior object and a surrounding cured portion of the photosensitive resin to determine whether there is adequate space for the interior object to be removed from the hollow portion.

7. The method of claim 1 wherein determining whether the interior object can be removed from the hollow portion is based at least in part on a machine learning analysis by a machine learning algorithm, and
wherein the machine learning algorithm is trained with a dataset comprising data indicating at least one of successful removals of a plurality of interior objects from a plurality of hollow portions, unsuccessful attempts to remove the plurality of interior objects from the plurality of hollow portions, shapes and dimensions of the plurality of hollow portions associated with at least one of the successful removals or the unsuccessful attempts to remove, or shapes and dimensions of the plurality of interior objects associated with at least one of the successful removals or the unsuccessful attempts to remove.

8. The method of claim 7 further comprising providing feedback to the machine learning algorithm to retrain the machine learning algorithm based on whether the interior object was able to be removed from the hollow portion following formation of the object.

9. The method of claim 1 further comprising:
generating, in response to determining that the interior object cannot be removed from the hollow portion following formation of the object, one or more designs where the interior object is divided into two or more portions; and
executing one or more additional computer-generated simulations to determine whether the interior object divided into the two or more portions can be removed from the hollow portion following formation of the object.

10. The method of claim 1 further comprising:
identifying, based at least in part on the computer-generated simulation, an alignment of the interior object in the photosensitive resin,
wherein the alignment corresponds to a designated location of the hollow portion; and
controlling, based at least in part on the alignment, an object movement system to immerse the interior object in the photosensitive resin.

11. The method of claim 10 further comprising controlling, based at least in part on the alignment, a direction of holographic ultraviolet (UV) light projected onto the photosensitive resin.

12. The method of claim 11 wherein the controlling of the object movement system and the controlling of the direction of the holographic UV light is based at least in part on feedback data including at least one of sensor data or image data associated with the interior object in the photosensitive resin.

13. A computer system comprising:
a processor set;
one or more computer-readable storage media; and
program instructions stored on the one or more computer-readable storage media to cause the processor set to perform operations comprising:
determining a geometry of a hollow portion of a first object that is to be manufactured through an application of holographic ultraviolet (UV) light to photosensitive resin;
generating a digital model of the hollow portion; and
executing a simulation with the digital model to determine a geometry of a second object that is to be used to form the hollow portion,
wherein the second object is to be placed in the photosensitive resin,
wherein the photosensitive resin is to be cured to form the first object around the second object, resulting in the second object being disposed in the hollow portion, and
wherein the geometry of the second object is based at least in part on whether the second object can be removed from the hollow portion following formation of the first object.

14. The computer system of claim 13 wherein the operations further comprise:
computing, based at least in part on the simulation, a minimum spacing between the second object and a portion of the photosensitive resin to be cured around the second object to permit the second object to be removed from the hollow portion following formation of the first object.

15. The computer system of claim 13 wherein the operations further comprise:
generating a first output based at least in part on the simulation to control a robotic system to place the second object in the photosensitive resin; and
generating a second output based at least in part on the simulation to control the robotic system to remove the second object from the hollow portion following formation of the first object.

16. The computer system of claim 13 wherein the operations further comprise:
receiving feedback from at least one of a sensor or a digital image source indicating whether movement of the photosensitive resin is occurring due to placement of the second object in the photosensitive resin; and
generating an output based at least in part on the feedback to control timing of the application of the holographic UV light to the photosensitive resin.

17. A computer program product comprising:
one or more computer-readable storage media; and
program instructions stored on the one or more computer-readable storage media to perform operations comprising:
generating a digital model of a hollow portion of a first object,
wherein the first object is to be formed from a resin, and
wherein the first object is to include a solid portion enclosing at least part of the hollow portion; and
using the digital model in a plurality of computer-generated simulations to determine a shape and dimensions of a second object,
wherein the shape and dimensions of the second object are to conform to a shape and dimensions of the hollow portion,
wherein the second object is be submerged in the resin,
wherein the first object is to be formed around the second object by curing the resin, resulting in the second object being disposed in the hollow portion, and
wherein the shape and dimensions of the second object are controlled in the plurality of computer-generated simulations to produce a version of the second object that is predicted to be removable from the hollow portion without causing damage to the first object.

18. The computer program product of claim 17 wherein the operations further comprise:
computing, based at least in part on a computer-generated simulation of the plurality of computer-generated simulations simulating formation of the first object around the second object, a clearance between the solid portion of the first object and an outer surface of the second object.

19. The computer program product of claim 18 wherein the operations further comprise:
determining, based at least in part on an additional computer-generated simulation of the plurality of computer-generated simulations simulating removal of the second object from the hollow portion, whether the clearance will permit removal of the second object from the hollow portion without causing damage to the first object.

20. The computer program product of claim 17 wherein the operations further comprise:
determining, based at least in part on the plurality of computer-generated simulations, that the version of the second object is to be divided along at least one axis to permit removal of the second object from the hollow portion without causing damage to the first object.
